(19) United States
(12) Patent Application Publication
(10) Pub. No.: US 2018/0270578 A1
(43) Pub. Date: Sep. 20, 2018

(54) VIBRATION DIAPHRAGM AND SPEAKER DEVICE

(71) Applicant: GOERTEK.INC, Weifang City, Shandong (CN)

(72) Inventors: Xiuli CHANG, Weifang City, Shandong (CN); Jianbin YANG, Weifang City, Shandong (CN)

(73) Assignee: GOERTEK.INC, Weifang City, Shandong (CN)

(21) Appl. No.: 15/556,091

(22) PCT Filed: Dec. 17, 2015
(86) PCT No.: PCT/CN2015/097753

§ 371 Date: Sep. 6, 2017

(30) Foreign Application Priority Data
Mar. 11, 2015 (CN) 201510106182.5

(51) Int. Cl. H04R 7/12; H04R 31/00

(52) U.S. Cl. CPC H04R 7/125; H04R 31/003; H04R 2307/029; H04R 2307/025; H04R 2307/023; H04R 7/127

(57) ABSTRACT

Disclosed are a vibration diaphragm and a speaker device. The vibration diaphragm includes a vibration diaphragm body portion and a reinforcement portion incorporated at the center of the vibration diaphragm body portion and including a carbon fiber cloth layer. The vibration diaphragm in the present invention employs a carbon fiber cloth with a relatively light weight and relatively high rigidity as the reinforcement portion, which can sufficiently satisfy the requirements to the vibration diaphragm acoustic performance by the speaker device.

### CROSS-REFERENCE TO RELATED APPLICATIONS

This application is a National Stage of International Application No. PCT/CN2015/097753, filed Dec. 17, 2015, which claims priority to Chinese Patent Application No. 201510106182.5, filed Mar. 11, 2015, both of which are hereby incorporated by reference in their entireties.

### TECHNICAL FIELD

The present invention relates to a vibration diaphragm and a speaker device.

### BACKGROUND

The vibration diaphragm of a speaker in the prior art usually includes a reinforcement portion at the center and a surround portion at the edge. The surround portion is usually made of a relatively flexible material. The reinforcement portion is made of a relatively rigid material. The rigid reinforcement portion can prevent the vibration diaphragm generating split vibration in the high frequency band and can improve the high frequency sound effect of the speaker product. In the ideal situation, the material of the reinforcement portion is required to be light in weight and high in rigidity. Thus, it is necessary to provide a reinforcement portion which has a relatively light weight and relatively high rigidity.

### SUMMARY

An object of the present invention is to provide a vibration diaphragm having a reinforcement portion with a relatively light weight and relatively high rigidity and a speaker device having the vibration diaphragm.

According to a first aspect of the present invention, a vibration diaphragm is provided, comprising a vibration diaphragm body portion and a reinforcement portion incorporated at the center of the vibration diaphragm body portion and including a carbon fiber cloth layer.

Preferably, the carbon fiber cloth layer is a woven carbon fiber cloth or unidirectional carbon fiber cloth; or the woven carbon fiber cloth is plain carbon fiber cloth or twill carbon fiber cloth.

Preferably, the carbon fiber cloth layer is a woven carbon fiber cloth and the vibration diaphragm body portion is made of an isotropic vibration diaphragm material; or the carbon fiber cloth is a unidirectional carbon fiber cloth and the vibration diaphragm body portion is made of an anisotropic vibration diaphragm material.

Preferably, the carbon fiber cloth layer is a woven carbon fiber cloth and the vibration diaphragm body portion is made of a TPU material; or the carbon fiber cloth is a unidirectional carbon fiber cloth and the vibration diaphragm body portion is made of a PEEK material; or the carbon fiber cloth is a unidirectional carbon fiber cloth and the vibration diaphragm body portion is made of a TPEE material.

Preferably, the carbon fiber cloth includes a plurality of layers of carbon fiber cloth laminated together.

Preferably, the carbon fiber cloth includes a carbon fiber preimpregnated cloth.

Preferably, the shape of the reinforcement portion is any one of: a flat plate, a dome and a straw hat.

Preferably, the vibration diaphragm body portion is made of a high polymer material or silicon rubber material.

Preferably, the reinforcement portion is adhered to the vibration diaphragm body portion; or the reinforcement portion is integrally injection-molded with the vibration diaphragm body portion; or the reinforcement portion is integrally hot-pressed with the vibration diaphragm body portion.

Preferably, the vibration diaphragm body portion is made of a high polymer material and the reinforcement portion is adhered to the vibration diaphragm body portion; or the vibration diaphragm body portion is made of a high polymer material and the reinforcement portion is integrally hot-pressed with the vibration diaphragm body portion; or the vibration diaphragm body portion is made of a silicon rubber material and the reinforcement portion is integrally injection-molded with the vibration diaphragm body portion.

Preferably, the vibration diaphragm body portion includes a central portion located in the middle and a surround portion at the edge, the portion of the central portion facing the reinforcement portion conforms with the shape of the reinforcement portion, and the reinforcement portion and the vibration diaphragm body portion are integrally formed.

Preferably, the vibration diaphragm body portion includes a central portion located in the middle and a surround portion at the edge, the central portion is provided with a recess where the reinforcement portion is embedded, and the reinforcement portion and the vibration diaphragm body portion are integrally formed.

According to a second aspect of the present invention, a speaker device is provided including a vibration diaphragm mentioned above.

The vibration diaphragm in the present invention adopts a carbon fiber cloth as the reinforcement portion. Since the carbon fiber cloth has the properties of low density, high strength and high modulus, it can sufficiently satisfy the performance requirements to the reinforcement portion by the vibration diaphragm and the acoustic performance requirements to the vibration diaphragm by the speaker device. The vibration diaphragm and the speaker device have the following technical effects.

1. The reinforcement portion with low density generates low Mms (vibration mass) and can enable the vibration diaphragm to obtain high sensitivity and high frequency response.

2. The reinforcement portion with high strength and high modulus can improve the transmission speed of high frequency acoustic waves and ensure high split vibration frequency of the vibration diaphragm portion at the reinforcement portion and the edge of the reinforcement portion to obtain a high resonance frequency and a broad high frequency band.

3. The carbon fiber cloth is resistant to high temperatures. The reinforcement portion cut already and the diaphragm of the vibration diaphragm (the vibration diaphragm body portion) can be connected as long as they are overlapped together and integrally formed through hot pressing during the manufacture of the vibration diaphragm, which is simple in the manufacture process and easy to implement.

The other features and advantages of the present invention will become clear according to the detailed description of exemplary embodiments of the present invention with reference to the accompanying drawings.

### BRIEF DESCRIPTION OF THE DRAWINGS

The accompanying drawings incorporated in the description and constituting a part of the description illustrate the embodiments of the present invention and used to explain the principle of the present invention along therewith.

FIG. 1 is a structure view of a vibration diaphragm according to a first embodiment of the present invention;

FIG. 2 is a structure view of a vibration diaphragm according to a second embodiment of the present invention;

FIG. 3 is a structure view of a vibration diaphragm according to a third embodiment of the present invention;

FIG. 4 is a structure view of a vibration diaphragm according to a fourth embodiment of the present invention;

FIG. 5 is a structure view of a vibration diaphragm according to a fifth embodiment of the present invention;

FIG. 6 is a structure view of a woven structure of a carbon fiber cloth according to a first embodiment of the present invention;

FIG. 7 is a structure view of a woven structure of a carbon fiber cloth according to a second embodiment of the present invention; and

FIG. 8 is a structure view of a woven structure of a carbon fiber cloth according to a third embodiment of the present invention.

### DETAILED DESCRIPTION

Various exemplary embodiments of the present invention will now be described in detail with reference to the accompanying drawings. It should be noted that unless stated specially otherwise, the relative arrangement of the components and steps illustrated in these embodiments, the numeral expressions and the values do not limit the scope of the present invention.

The description of at least one exemplary embodiment of the present invention is actually merely illustrative rather than limiting the present invention and the application or use thereof.

Technologies, methods and devices known to those skilled in the art may not be described in detail but these technologies, method and device shall be regarded as a part of the description when appropriate.

Any particular value in all examples illustrated and described here shall be construed as merely illustrative rather than limiting. Thus, other examples of the exemplary embodiments may have different values.

It should be noted that similar signs and letters represent similar items in the following figures, and thus, once a certain item is defined in a figure, there is no need to further describe the same in the subsequent figures.

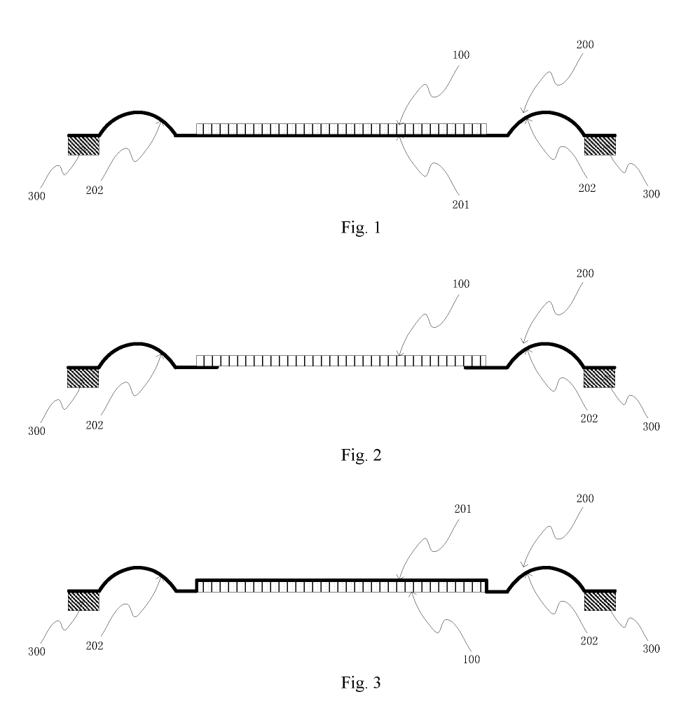

Referring to FIGS. 1 to 5, according to a first aspect of the present invention, a vibration diaphragm is proposed, comprising a vibration diaphragm body portion 200 and a reinforcement portion 100 incorporated at the center of the vibration diaphragm body portion 200 and including a carbon fiber cloth layer. The vibration diaphragm body portion 200 is fixed on a support member 300 of the vibration diaphragm. The reinforcement portion 100 may be of a flat plate shape, a dome shape, a straw hat shape and so on. The flat plate shape may be a rectangle, a circle or an oval.

Referring to the first embodiment shown in FIG. 1, the vibration diaphragm body portion 200 includes a central portion 201 located in the middle and a surround portion 202 located at the edge. The central portion 201 and the reinforcement portion 100 are both of a flat plate shape and may be adhered to each other.

Referring to the second embodiment shown in FIG. 2, the vibration diaphragm body portion 200 is of a hollow structure and a surround structure 202 is provided at the edge. The reinforcement portion 100 is located at the center of the vibration diaphragm body portion 200. In the second embodiment, the edge portion of the reinforcement portion 100 is partially overlapped with the vibration diaphragm body portion 200, and the two can be adhered to each other.

Referring to the third embodiment shown in FIG. 3, the vibration diaphragm body portion 200 includes a central portion 201 located in the middle and a surround portion 202 located at the edge. The central portion 201 is provided with a recess where the reinforcement portion 100 is embedded. The reinforcement portion 100 and the vibration diaphragm body portion 200 may be integrally injection-molded. Furthermore, the support member 300 may also be integrally injection-molded therewith. Of course, the reinforcement portion 100 and the vibration diaphragm body portion 200 may also be integrally hot-pressed or adhered to each other.

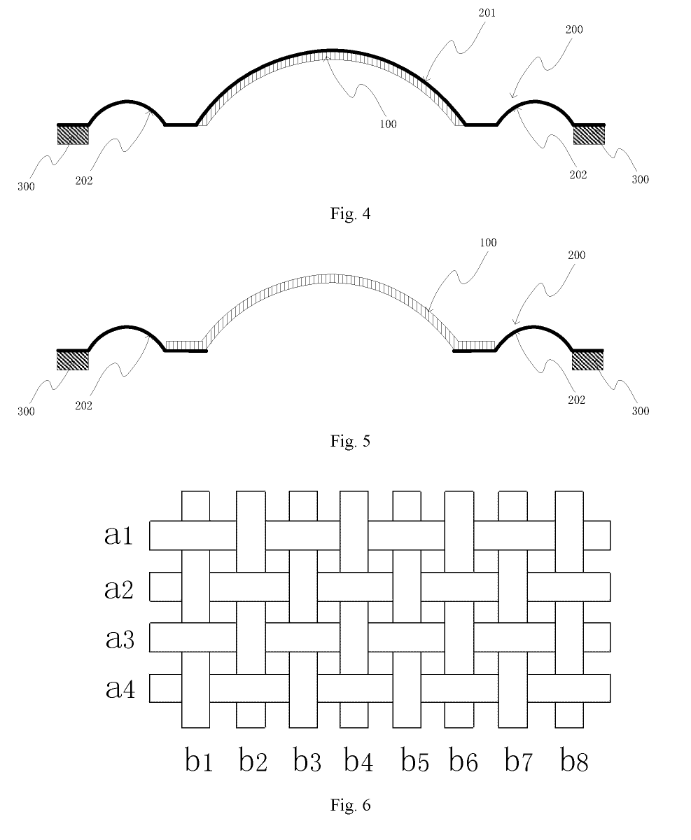

Referring to the fourth embodiment shown in FIG. 4, the vibration diaphragm body portion 200 includes a central portion 201 located in the middle and a surround portion 202 located at the edge. The part of the central portion 201 directly facing the reinforcement portion 100 has a conforming shape to that of the reinforcement portion 100, which means that the reinforcement portion 100 can be closely adhered to the central portion 201. In this embodiment, the reinforcement portion 100 is of a dome shape and may also be of a straw hat shape. The reinforcement portion 100 and the vibration diaphragm body portion 100 may be integrally injection-molded, may also be integrally hot-pressed or adhered to each other.

Referring to the fifth embodiment shown in FIG. 5, the vibration diaphragm body portion 200 is of a hollow structure and the surround structure 202 is provided at the edge. The reinforcement portion 100 is located at the center of the vibration diaphragm body portion 200. Being different from the second embodiment, the reinforcement portion 100 is of a straw hat shape. In the fifth embodiment, the edge portion of the reinforcement portion 100 is partially overlapped with the vibration diaphragm body portion 200, and the two can be adhered to each other.

The connection manner between the reinforcement portion and the vibration diaphragm body portion may be any one of: adhesion, integral injection molding, and integral hot pressing. During integral hot pressing, the carbon fiber cloth (reinforcement portion) cut already and the diaphragm of the vibration diaphragm (vibration diaphragm body portion) may be stacked together first and then integrally hot-pressed. Integral forming reduces the adhesion process and is good in stability and conformity.

The vibration diaphragm body portion may be made of a polymer material or silicon rubber material. Preferably, the vibration diaphragm body portion is made of a high polymer material and the reinforcement portion is adhered to the vibration diaphragm body portion. Or the vibration diaphragm body portion is made of a high polymer material and the reinforcement portion is integrally hot-pressed with the vibration diaphragm body portion. Or the vibration diaphragm body portion is made of a silicon rubber material and the reinforcement portion is integrally injection-molded with the vibration diaphragm body portion. During integral injection molding, the reinforcement portion (reinforcement portion) cut already is placed in an injection mold such that the silicon rubber vibration diaphragm body portion and the reinforcement portion are injection-molded together.

Hereinafter, the structure of the carbon fiber cloth used by the reinforcement portion will be introduced.

The carbon fiber cloth may be formed by arranging or weaving of carbon fiber lines. The section of the carbon fiber line may be rectangular or circular or oval. Further, the carbon fiber cloth may be treated by an impregnation process to form a carbon fiber preimpregnated cloth. Preimpregnation may seal the gaps and woven meshes between carbon fiber lines and facilitate subsequent formation. The carbon fiber cloth layer is a single layer of carbon fiber cloth or includes a plurality of layers of carbon fiber cloth laminated together. The lamination of the plurality of layers of carbon fiber cloth can increase the stiffness and strength of the reinforcement portion and also can further seal the gaps and woven meshes between the carbon fiber lines.

The woven structure of the carbon fiber cloth may be a plain woven structure. Referring to FIG. 6, the plain woven structure is that the longitude lines sink and emerge in the latitude lines alternately in the latitude direction, and the sinking and emerging of adjacent longitude lines are opposite. For example, longitude lines are a1-a4, and latitude lines are b1-b8. Since the carbon fiber lines are woven alternately in longitude and latitude directions, the plain carbon fiber cloth has the same elasticity in the two directions. The texture of the plain fabric is firm and flat in appearance. The size of the mesh can be adjusted according to actual needs.

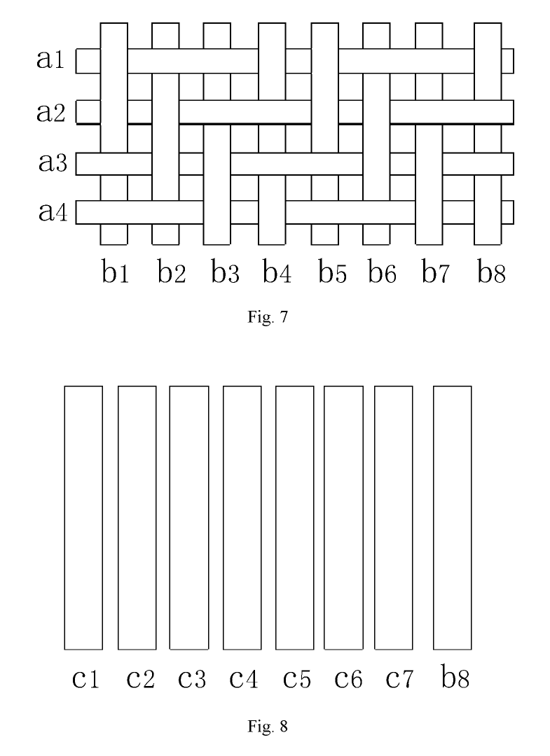

The woven structure of the carbon fiber cloth may also be a twill woven structure. The organization points of the twill woven structure are continuous to form diagonal lines. FIG. 7 shows an embodiment of a twill woven structure. Each latitude line sinks and emerges alternately above two longitude lines and also sinks and emerges alternately under two longitude lines. For example, longitude lines are a1-a4, and latitude lines are b1-b8. The twill carbon fiber cloth has the same elastic strength in two directions.

If the plain or twill carbon fiber cloth is taken as the reinforcement portion, the vibration diaphragm body portion preferably adopts an isotropic material to ensure the isotropic property of the vibration system of the product. The isotropic vibration diaphragm material is for example TPU (Thermoplastic polyurethanes).

The above has given two embodiments of the woven structure. Of course, the carbon fiber cloth may also be a woven structure combining plain and twill weaving.

Referring to FIG. 8, the carbon fiber cloth layer is a unidirectional carbon fiber cloth, which means that each carbon fiber line is arranged in the same direction without intersection, such as carbon fiber lines c1-c8. Since the carbon fiber lines per se have directivity, the unidirectional carbon fiber cloth is directional in a two-dimensional space and has different elastic properties in two directions.

If the unidirectional carbon fiber cloth is used as the reinforcement portion, the vibration diaphragm body portion preferably adopts an anisotropic material to ensure balanced vibration of the vibration system of the product without causing polarization. The anisotropic vibration diaphragm material is for example PEEK (Polyetheretherketone) or TPEE (Thermoplastic polyurethanes).

The reinforcement portion may be obtained after performing hot pressing or other formation process on the carbon fiber cloth and then cutting the same. The reinforcement portion 100 may be of a flat plate shape, a dome shape, a straw hat shape and so on. The flat plate shape may be a rectangle, a circle or an oval.

According to a second aspect of the present invention, a speaker device is proposed including a vibration diaphragm mentioned above.

The vibration diaphragm in the present invention adopts a carbon fiber cloth as the reinforcement portion (DOME). Since the carbon fiber cloth has the properties of low density, high strength and high modulus, it can sufficiently satisfy the performance requirements to the reinforcement portion by the vibration diaphragm and the acoustic performance requirements to the vibration diaphragm by the speaker device. The vibration diaphragm and the speaker device have the following technical effects.

1. The reinforcement portion with low density generates low Mms (vibration mass) and can enable the vibration diaphragm to obtain high sensitivity and high frequency response.

2. The reinforcement portion with high strength and high modulus can improve the transmission speed of high frequency acoustic waves and ensure high split vibration frequency of the vibration diaphragm portion at the reinforcement portion and the edge of the reinforcement portion to obtain a high resonance frequency and a broad high frequency band.

3. The carbon fiber cloth is resistant to high temperatures. The reinforcement portion cut already and the diaphragm of the vibration diaphragm (the vibration diaphragm body portion) can be connected as long as they are overlapped together and integrally formed through hot pressing during the manufacture of the vibration diaphragm, which is simple in the manufacture process and easy to implement.

Although some specific embodiments of the present invention have been described in detail by way of example, it should be understood by those skilled in the art that the above examples are merely for the sake of description rather than limiting the scope of the present invention. It should be understood by those skilled that the above embodiments may be modified without departing from the scope and spirit of the present invention.

1. A vibration diaphragm, comprising a vibration diaphragm body portion and a reinforcement portion incorporated at the center of the vibration diaphragm body portion and including a carbon fiber cloth layer.

2. The vibration diaphragm according to claim 1, wherein the carbon fiber cloth layer is a woven carbon fiber cloth or unidirectional carbon fiber cloth; and the woven carbon fiber cloth is a plain carbon fiber cloth or twill carbon fiber cloth.

3. The vibration diaphragm according to claim 2, wherein the carbon fiber cloth layer is a woven carbon fiber cloth and the vibration diaphragm body portion is made of an isotropic vibration diaphragm material; or the carbon fiber cloth is a unidirectional carbon fiber cloth and the vibration diaphragm body portion is made of an anisotropic vibration diaphragm material.

4. The vibration diaphragm according to claim 2, wherein the carbon fiber cloth layer is a woven carbon fiber cloth and the vibration diaphragm body portion is made of a TPU material; or the carbon fiber cloth is a unidirectional carbon fiber cloth and the vibration diaphragm body portion is made of a PEEK material; or the carbon fiber cloth is a unidirectional carbon fiber cloth and the vibration diaphragm body portion is made of a TPEE material.

5. The vibration diaphragm according to claim 1, wherein the carbon fiber cloth includes a plurality of layers of carbon fiber cloth laminated together.

6. The vibration diaphragm according to claim 1, wherein the carbon fiber cloth includes a carbon fiber preimpregnated cloth.

7. The vibration diaphragm according to claim 1, wherein the shape of the reinforcement portion is any one of: a flat plate, a dome and a straw hat.

8. The vibration diaphragm according to claim 1, wherein the vibration diaphragm body portion is made of a high polymer material or silicon rubber material.

9. The vibration diaphragm according to claim 1, wherein the reinforcement portion is adhered to the vibration diaphragm body portion; or the reinforcement portion is integrally injection-molded with the vibration diaphragm body portion; or the reinforcement portion is integrally hot-pressed with the vibration diaphragm body portion.

10. The vibration diaphragm according to claim 1, wherein the vibration diaphragm body portion is made of a high polymer material and the reinforcement portion is adhered to the vibration diaphragm body portion; or the vibration diaphragm body portion is made of a high polymer material and the reinforcement portion is integrally hot-pressed with the vibration diaphragm body portion; or the vibration diaphragm body portion is made of a silicon rubber material and the reinforcement portion is integrally injection-molded with the vibration diaphragm body portion.

11. The vibration diaphragm according to claim 1, wherein the vibration diaphragm body portion includes a central portion located in the middle and a surround portion at the edge, the portion of the central portion facing the reinforcement portion conforms with the shape of the reinforcement portion, and the reinforcement portion and the vibration diaphragm body portion are integrally formed.

12. The vibration diaphragm according to claim 1, wherein the vibration diaphragm body portion includes a central portion located in the middle and a surround portion at the edge, the central portion is provided with a recess where the reinforcement portion is embedded, and the reinforcement portion and the vibration diaphragm body portion are integrally formed.

13. A speaker device, comprising a vibration diaphragm according to claim 1.
